(19) United States
(12) Patent Application Publication
(10) Pub. No.: US 2025/0085873 A1
(43) Pub. Date: Mar. 13, 2025

(54) MEMORY CONTROL CIRCUIT AND CONTROL METHOD THEREOF

(71) Applicant: REALTEK SEMICONDUCTOR CORP., HsinChu (TW)

(72) Inventors: Kuo-Lun Huang, HsinChu (TW); Shih-Han Lin, HsinChu (TW)

(73) Assignee: REALTEK SEMICONDUCTOR CORP., HsinChu (TW)

(21) Appl. No.: 18/824,080

(22) Filed: Sep. 4, 2024

(30) Foreign Application Priority Data
Sep. 7, 2023 (TW) 112134157

(51) Int. Cl. G06F 3/06

(52) U.S. Cl. CPC G06F 3/0625; G06F 3/0634; G06F 3/0673

(57) ABSTRACT

A memory control circuit includes an access control circuit, a connection pad circuit, and a pad control circuit. The connection pad circuit includes a transceiver circuit and a receiver circuit. The transceiver circuit and the receiver circuit are connected to a memory through an external pad. The pad control circuit is connected between the access control circuit and the receiver circuit. The pad control circuit executes a read command, and receives data from the memory. The pad control circuit executes a write command or receives the data, the pad control circuit turns off the output of the receiver circuit. The access control circuit executes a power save command that the receiver circuit enters a power save mode. The pad control circuit decreases an operating current of the receiver circuit to minimum and forces an internal signal level of the receiver circuit. The receiver circuit enters a deep power save state.

### CROSS-REFERENCE TO RELATED APPLICATION

This non-provisional application claims priority under 35 U.S.C. § 119(a) to Patent Application No. 112134157 filed in Taiwan, R.O.C. on Sep. 7, 2023, the entire contents of which are hereby incorporated by reference.

### BACKGROUND

### Technical Field

The present invention relates to the field of memories, and in particular, to a memory control circuit and power save control method thereof.

### Related Art

In the past, in use of a memory (for example, Double Data Rate Synchronous Dynamic Random Access Memory, DDR SDRAM), to reduce power consumption of the memory, the most common method is to enable the memory to enter a power down mode frequently. However, when the memory enters a read mode from the power down mode, a receiver cannot successfully receive data immediately after waking up, affecting the operation of an entire system.

### SUMMARY

In some embodiments, a memory control circuit includes an access control circuit, a connection pad circuit, and a pad control circuit. The access control circuit sends a read command, a write command, or a power save command. The connection pad circuit includes a transceiver circuit and a receiver circuit. The transceiver circuit and the receiver circuit are connected to a memory through an external pad. The pad control circuit is connected between the access control circuit and the receiver circuit. The pad control circuit executes the read command to enable the receiver circuit to receive read data from the memory through the external pad. The pad control circuit executes the write command or receives the read data to turn off output of the receiver circuit to enable the receiver circuit to enter a power save state, then executes the power save command to decrease an operating current of the receiver circuit and forces an internal signal of the receiver circuit to a level to enable the receiver circuit to enter a deep power save state.

In some embodiments, the receiver circuit includes a current mirror circuit, a comparator group, an output stage, and a switch circuit. The current mirror circuit is controlled by the pad control circuit. The current mirror circuit maps an input current to generate the operating current. The comparator group is connected to the external pad. The comparator group is powered by the operating current. The output stage is connected between the comparator group and the pad control circuit. The switch circuit is connected to the comparator group. The switch circuit is controlled by the pad control circuit.

In some embodiments, the switch circuit includes an operating switch. The operating switch is connected between the current mirror circuit and the comparator group. The operating switch is controlled by the pad control circuit. In the deep power save state, the pad control circuit further controls the operating switch to disconnect a power supply path that is between the current mirror circuit and the comparator group and that is configured to provide the operating current for the comparator group.

In some embodiments, in the deep power save state, the pad control circuit controls the switch circuit to connect a plurality of input ends of the comparator group to a power supply and to a ground respectively to force the internal signal of the receiver circuit to the level.

In some embodiments, in the power save state and the deep power save state, the pad control circuit forces the output stage to be in a non-output state to turn off the output of the receiver circuit.

In some embodiments, the output stage is an AND gate. The pad control circuit provides a logic signal to an input end of the AND gate to force the output stage to be in the non-output state, and the logic signal is 0.

In some embodiments, the receiver circuit further includes a current switch. The current switch is connected between the current mirror circuit and the ground. The current switch executes a power down command to disconnect the current mirror circuit from the ground, to enable the receiver circuit to enter a power down state.

In some embodiments, the comparator group includes a plurality of comparators. The plurality of comparators are connected in series between the external pad and the pad control circuit. In the deep power save state, the pad control circuit controls the switch circuit to disconnect the current mirror circuit to turn off a first comparator in the plurality of comparators, and controls the switch circuit to connect two input ends of each of remaining comparators in the plurality of comparators to a power supply and to a ground respectively to force the internal signal of the receiver circuit to the level.

In some embodiments, the current mirror circuit includes a current mirror and a current adjustment circuit. The current mirror maps an input current to the operating current. The current adjustment circuit is connected to the current mirror. The current adjustment circuit is controlled by the pad control circuit, and is configured to adjust the input current.

In some embodiments, a memory control circuit control method includes receiving a read command; executing the read command to receive read data from a memory by a receiver circuit; controlling the receiver circuit to enter a power save state after the read data is received or a write command is executed; and executing a power save command to control the receiver circuit to enter a deep power save state from the power save state. A step of entering the power save state includes: turning off output of the receiver circuit. A step of entering the deep power save state includes: turning off the output of the receiver circuit; decreasing an operating current of the receiver circuit to the minimum; and forcing an internal signal of the receiver circuit to the level.

In some embodiments, a power down state is entered from the power save state or the deep power save state. A step of entering the power down state includes: turning off the receiver circuit.

In some embodiments, the step of entering the deep power save state further includes: disconnecting a power supply path for providing the operating current to the receiver circuit.

In some embodiments, a step of forcing the internal signal of the receiver circuit to the level includes: connecting a plurality of input ends of a comparator group to a power supply and to a ground respectively.

In some embodiments, a step of turning off the output of the receiver circuit includes: forcing an output stage of the receiver circuit to be in a non-output state.

In some embodiments, the output stage is an AND gate. A step of forcing the output stage of the receiver circuit to be in the non-output state is to provide a logic signal to an input end of the AND gate, and the logic signal is 0.

In some embodiments, a step of decreasing the operating current of the receiver circuit to the minimum includes: decreasing an input current, where the operating current is generated by mapping the input current.

In some embodiments, a power down state is entered from the power save state or the deep power save state. A step of entering the power down state includes: cutting off the input current.

In some embodiments, the receiver circuit includes a plurality of comparators. A step of forcing the internal signal of the receiver circuit to the level includes: turning off a first comparator in the plurality of comparators, and connecting two input ends of each of remaining comparators in the plurality of comparators to a power supply and to a ground respectively.

In summary, according to the memory control circuit and the control method thereof of any embodiment, a memory control circuit that is idle in power save state is switched from a power save mode to a deep power save mode, and the receiver circuit is enabled to enter a deep power save state from a power save state, thereby greatly reducing overall power consumption of the memory control circuit without reducing system performance. In other words, when a read operation is needed, the memory control circuit can instantly switch to a read mode from the deep power save mode, that is, the memory control circuit can instantly wake up the receiver circuit to successfully receive read data.

### BRIEF DESCRIPTION OF THE DRAWINGS

FIG. 1 is a functional block diagram of a memory control circuit according to an embodiment;

FIG. 2 is a flowchart of a memory control circuit control method according to an embodiment;

FIG. 3 is a functional block diagram according to an embodiment of a receiver circuit of FIG. 1; and

FIG. 4 is a schematic diagram of a circuit according to an embodiment of a receiver circuit of FIG. 2.

### DETAILED DESCRIPTION

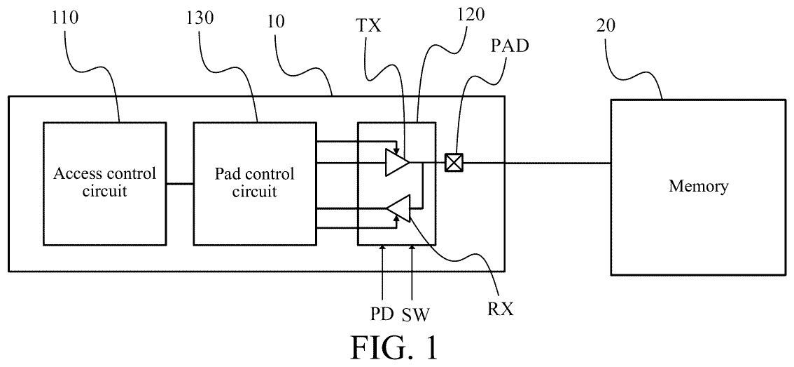

FIG. 1 shows a memory control circuit 10, which is suitable for controlling a read/write operation of a memory 20. The memory control circuit 10 includes an access control circuit 110, a connection pad circuit 120, and a pad control circuit 130. The connection pad circuit 120 includes a transceiver circuit TX and a receiver circuit RX. The access control circuit 110 is connected to the pad control circuit 130. The connection pad circuit 120 is connected to the pad control circuit 130. The connection pad circuit 120 is connected to an external pad PAD. In other words, the pad control circuit 130 is connected between the access control circuit 110 and the connection pad circuit 120. In addition, the connection pad circuit 120 is connected to the memory 20 through the external pad PAD. The transceiver circuit TX and the receiver circuit RX are connected between the external pad PAD and the pad control circuit 130.

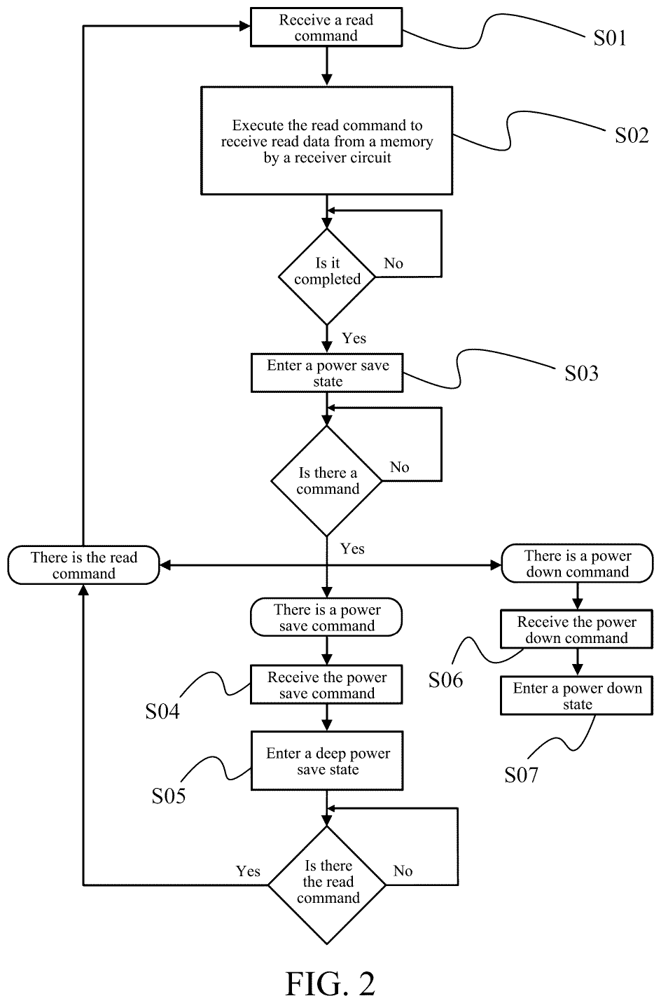

Referring to FIG. 1 and FIG. 2, the access control circuit 110 is configured to control an operation of the memory 20. Specifically, when a read operation needs to be performed on the memory 20, the access control circuit 110 may send a read command to the pad control circuit 130. After the pad control circuit 130 receives the read command (step S01), the pad control circuit 130 may execute the received read command to perform the read operation. In other words, the receiver circuit RX is enabled to receive read data form the memory 20 through the external pad PAD (step S02).

When no read operation is performed, that is, when the memory control circuit 10 is idle or a write operation is performed (that is, when the read command is executed or a write command is received), the memory control circuit 10 may enter a power save mode (step S03) to save power consumption. Specifically, when the read command is executed and the write command is received (for example, when the memory control circuit 10 is idle or the write operation is performed), the pad control circuit 130 controls the receiver circuit RX to enter a power save state (step S03). In the power save state (step S03), the pad control circuit 130 turns off output of the receiver circuit RX.

In addition, when being idle for a short time, the memory control circuit 10 may further switch to a deep power save mode from the power save mode, so as to significantly reduce power consumption of the memory control circuit 10 without reducing system performance. Specifically, when the memory control circuit 10 is to switch to the deep power save mode from the power save mode, the access control circuit 110 may send a power save command to the pad control circuit 130. After the pad control circuit 130 receives the power save command (step S04), the pad control circuit 130 may execute the power save command to control the receiver circuit RX to enter a deep power save state from the power save state (step S05). In step S05, the pad control circuit 130 turns off the output of the receiver circuit, decreases an operating current of the receiver circuit RX to the minimum, and forces an internal signal of the receiver circuit RX to a level. In some embodiments, in the deep power save state (step S05), an internal signal of the receiver circuit RX may be forced to a level such as a power supply voltage or a ground voltage. The ground voltage may be 0 V.

In this way, when being idle or performing the write operation, the memory control circuit 10 can turn off the output of the receiver circuit RX through the pad control circuit 130 to reduce overall power consumption. To save power consumption, the memory control circuit 10 may further decrease the operating current of the receiver circuit RX through the pad control circuit 130 and bind the internal signal of the receiver circuit RX to reduce power supply and avoid leakage. Therefore, when the memory control circuit 10 receives the read command in the power save mode or the deep power save mode, the pad control circuit 130 can immediately execute the read command and immediately wake up the receiver circuit RX to successfully receive the read data, such that system performance is not reduced.

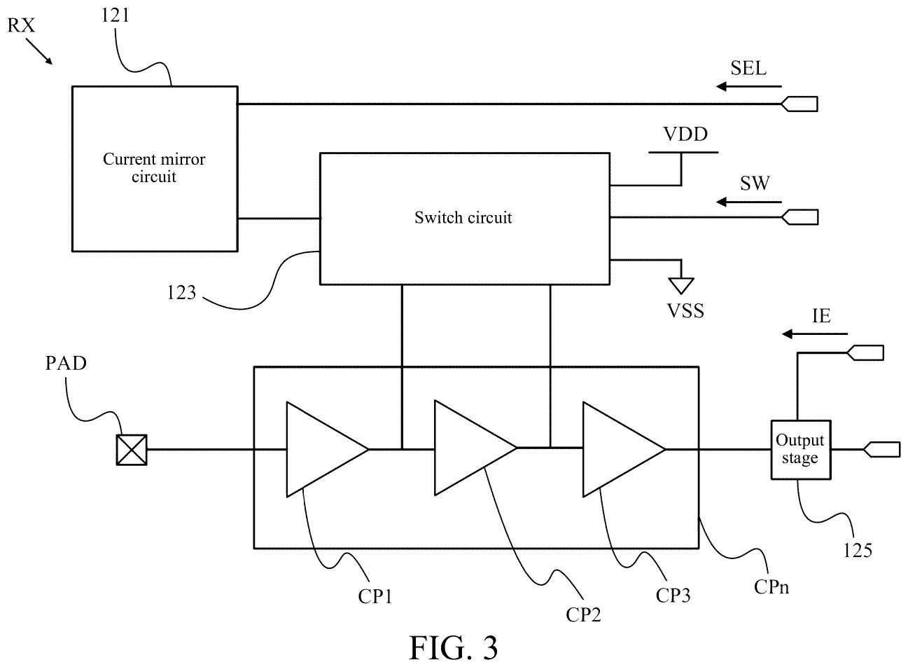

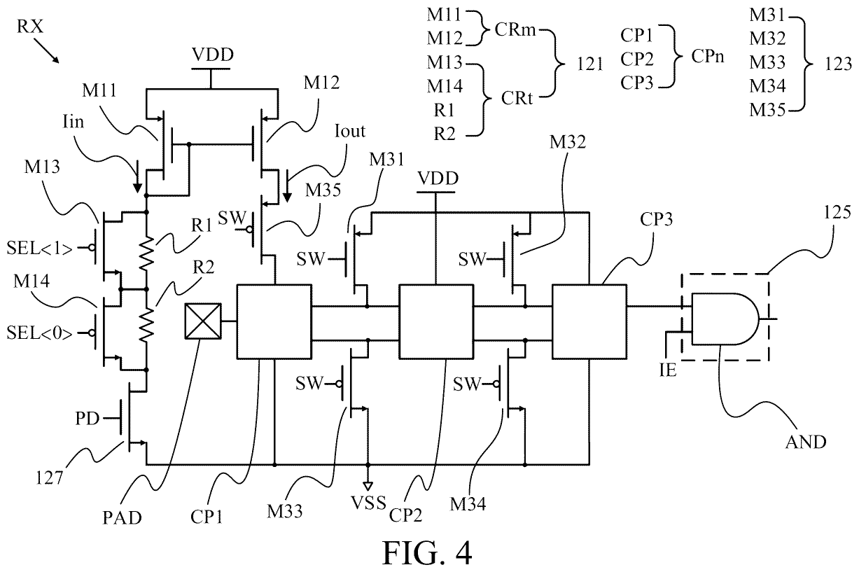

Referring to FIG. 1, FIG. 3, and FIG. 4, in some embodiments, the receiver circuit RX includes a current mirror circuit 121, a comparator group CPn, an output stage 125, and a switch circuit 123. The current mirror circuit 121 is connected to the pad control circuit 130, and the current mirror circuit 121 is controlled by the pad control circuit 130. The current mirror circuit 121 obtains an operating current Iout by mapping from on an input current Iin based on circuit characteristics of the current mirror circuit 121. The comparator group CPn is connected between the external pad PAD and the output stage 125, and the comparator group CPn is powered by the operating current Iout. The output stage 125 is connected between the comparator group CPn and the pad control circuit 130. The switch circuit 123 is connected to the current mirror circuit 121, the comparator group CPn, and the pad control circuit 130, which enables the switch circuit 123 to be controlled by the pad control circuit 130.

Referring to FIG. 1 to FIG. 3, in some embodiments, in step S04 and step S05, the pad control circuit 130 forces the output stage 125 to be in a non-output state to turn off the output of the receiver circuit RX, so as to reduce overall power consumption of the memory control circuit 10

Referring to FIG. 1 to FIG. 4, in some embodiments, the output stage 125 is an AND gate AND. The pad control circuit 130 is connected to an input end of the output stage 125 of the AND gate AND, and the comparator group CPn is connected to another input end of the AND gate AND. In step S04 and step S05, the pad control circuit 130 provides a logic signal IE to the input end of the output stage 125 of the AND gate AND to force the output stage 125 to be in the non-output state, and the logic signal is 0.

In some embodiments, the memory control circuit 10 may further switch to a power down mode from the power save mode or the deep power save mode, so as to significantly reduce power consumption of the memory control circuit 10. Specifically, when the memory control circuit 10 is to switch to the power down mode from the power save mode or the deep power save mode, the pad control circuit 130 may receive a power down command (step S06), and the pad control circuit 130 may execute the power down command to control the receiver circuit RX to enter a power down state from the power save state or the deep power save state (step S07). In step S07, the pad control circuit 130 may execute the power down command to connect the current mirror circuit 121 to a ground VSS, to enable the receiver circuit RX to enter the power down state.

Referring to FIG. 4, in some embodiments, the receiver circuit RX further includes a current switch 127. The current switch 127 is connected between the current mirror circuit 121 and the ground VSS, and the current switch 127 is controlled by the pad control circuit 130. After the pad control circuit 130 receives the power down command (step S06), in step S07, the pad control circuit 130 executes the read command or the write command to control the current switch 127 to disconnect the current mirror circuit 121 from the ground VSS. Specifically, when the receiver circuit RX is in any of a read state, the power save state, the deep power save state, and the like, the current switch 127 may remain in an on state. The pad control circuit 130 may control the current switch 127 to switch to an off state from an on state and remain in the off state after receiving the power down command, and a current path between the current mirror circuit 121 and the ground VSS is disconnected and the input current Iin cannot flow, and then the operating current Iout cannot be generated by mapping, so that the entire receiver circuit RX has no power and stops operating.

In some embodiments, the current switch 127 may be implemented as a transistor. This transistor may be a bipolar junction transistor, a metal-oxide-semiconductor field-effect transistor, a field-effect transistor, or an insulated gate bipolar transistor.

That the current switch 127 is an NMOS is used as an example. Two ends of the current switch 127 are connected to the current mirror circuit 121 and the ground VSS respectively. A control end of the current switch 127 is connected to the pad control circuit 130, and is configured to receive a mode signal PD from the pad control circuit 130. The current switch 127 is normally in the on state. In other words, the current switch 127 receives a mode signal PD with logic 0 or a low level. In step S07, the pad control circuit 130 may be changed to output a mode signal PD with logic 1 or a high level to the current switch 127, so that the current switch 127 executes the mode signal PD with logic 1 or the high level to switch to the off state, and then the current mirror circuit 121 and the ground VSS are disconnected, so that the input current Iin input to the current mirror circuit 121 is turned off.

In some embodiments, to further save power consumption, in step S05, the memory control circuit 10 may further stop power supply to a currently unused circuit in the receiver circuit RX through the pad control circuit 130.

Referring to FIG. 1 to FIG. 4, in some embodiments, the switch circuit 123 includes an operating switch M35. The operating switch M35 is connected between the current mirror circuit 121 and the comparator group CPn. The operating switch M35 is controlled by the pad control circuit 130. Normally (for example, the receiver circuit RX is in any of the read state, the power save state, and the like), the pad control circuit 130 controls the operating switch M35 to maintain in the on state to connect the current mirror circuit 121 to the comparator group CPn. In other words, the operating switch M35 in the on state is used as a power supply path to supply the operating current Iout from the current mirror circuit 121 to the comparator group CPn. For the power save state, in step S05, the pad control circuit 130 controls the operating switch M35 to form the off state to disconnect the power supply path between the current mirror circuit 121 and the comparator group CPn.

In some embodiments, the operating switch M35 may be implemented as a transistor such as a bipolar junction transistor, a metal-oxide-semiconductor field-effect transistor, a field-effect transistor, or an insulated gate bipolar transistor.

In an embodiment, in the power save state in step S05, the pad control circuit 130 may control the switch circuit 123 to connect a plurality of input ends of the comparator group CPn to a power supply VDD (which provides power supply voltage) or the ground VSS (which provides ground voltage) to force the internal signal of the receiver circuit RX to the level.

In an embodiment, the comparator group CPn includes n comparators CP1 to CP3, where n is a positive integer greater than 1. These comparators CP1 to CP3 are connected in series between the external pad PAD and the output stage 125. In other words, the output stage 125 is coupled between the comparator CP3 of the last stage and the pad control circuit 130. In some embodiments, the comparator group CPn may be a series circuit consisting of n comparators CP1 to CP3.

In some embodiments, in step S05, the pad control circuit 130 controls the switch circuit 123 to connect two input ends (hereinafter referred to as a first end and a second end respectively) of each of the comparators CP2 and CP3 of the second stage to the last stage to the power supply VDD and the ground VSS respectively to force the internal signal of the receiver circuit RX to the level.

In some embodiments, the switch circuit 123 further includes 2(n−1) short-circuit switches M31 to M34. The comparators CP2 and CP3 of the second stage to the last stage correspond to a pair of short-circuit switches M31 to M34 respectively. The first end of each of the comparators CP2 and CP3 of the second stage to the last stage is connected to the power supply VDD through one short-circuit switch M31/M32 of two corresponding short-circuit switches M31, M33/M32, M34, and the second end of each of the comparators CP2 and CP3 of the second stage to the last stage is connected to the ground VSS through the other short-circuit switch M31/M32 of the two corresponding short-circuit switches M31, M33/M32, M34. Control ends of a same pair of short-circuit switches M31, M33/M32, M34 are connected to the pad control circuit 130. In step S05, the pad control circuit 130 outputs a control signal SW to the control ends of these short-circuit switches M31 to M34 to turn on the short-circuit switches M31 to M34, thereby short-circuiting the first ends of the comparators CP2 and CP3 of the second stage to the last stage to the power supply VDD and short-circuiting the second ends of the comparators CP2 and CP3 of the second stage to the last stage to the ground VSS. In this way, input signals of these comparators CP2 and CP3 are bound to the level of the power supply VDD or the ground VSS.

In an embodiment, control of the control signal SW is determined by the mode signal PD, the logic signal IE, and the power save command. When the mode signal PD is 0, and the logic signal IE is 1, the control signal SW is 1, then the memory control circuit 10 is in the read mode, and the receiver circuit RX is turned on. When the mode signal PD is 0, and the logic signal IE is 0, the control signal SW is 1, then the memory control circuit 10 is idle or the write operation is performed, and the receiver circuit RX is turned off to enter the power save state. When the mode signal PD is 0, the logic signal IE is 0, and the power save command is received, the control signal SW is 0, then the memory control circuit 10 is idle or the write operation is performed, and the receiver circuit RX is turned off to enter the deep power save state. When the mode signal is 1, and the control signal is 0, then the memory control circuit 10 is in the power down mode, and the receiver circuit RX is turned off.

In an embodiment, each short-circuit switch M31/M32/M33/M34 may be implemented as a transistor, and the transistor may be a bipolar junction transistor, a metal-oxide-semiconductor field-effect transistor, a field-effect transistor, or an insulated gate bipolar transistor.

That a quantity of n comparators CP1, CP2, and CP3 is three is used as an example, and the switch circuit 123 includes four short-circuit switches M31, M32, M33, M34 and an operating switch M35. The three comparators CP1, CP2, and CP3 are sequentially connected in series between the external pad PAD and the output stage 125. The first comparator CP1 is connected to the current mirror circuit 121 through the operating switch M35. Two output ends of the second comparator CP2 are connected to the power supply VDD and the ground VSS through the short-circuit switches M31 and M33 respectively. Two output ends of the last comparator CP3 are connected to the power supply VDD and the ground VSS through the short-circuit switches M32 and M34 respectively. The control ends of the short-circuit switches M31 to M34 and the control end of the operating switch M35 are connected to the pad control circuit 130, and are configured to receive the control signal SW from the pad control circuit 130.

In step S05, the pad control circuit 130 controls the operating switch M35 to form a cut-off to disconnect a power supply path between the current mirror circuit 121 and the comparator CP1 of the first stage, to enable the comparator CP1 of the first stage to be turned off. The pad control circuit 130 controls the four short-circuit switches M31 to M34 to form a connection, to enable two input ends of each of the remaining comparators CP2 and CP3 to be connected to the power supply VDD and the ground VSS respectively, so that the internal signal of the receiver circuit RX is forced to the level of the power supply VDD or to the level of the ground VSS.

That the short-circuit switches M31 and M32 are PMOS and the short-circuit switches M33 and M34 and the operating switch M35 are NMOS is used as an example. The control ends of the short-circuit switches M31 and M32 and the control end of the operating switch M35 are provided with inverters. In this case, one end of the operating switch M35 is connected to an output end of the current mirror circuit 121, and the other end of the operating switch M35 is connected to a power supply end of the first comparator CP1. The control end of the operating switch M35 is connected to the pad control circuit 130, and is configured to receive the control signal SW from the pad control circuit 130. One end of the short-circuit switch M31 and one end of the short-circuit switch M32 are connected to the power supply VDD, and the other end of the short-circuit switch M31 and the other end of the short-circuit switch M32 are connected to one input end of the comparator CP2 of the second stage and one input end of the comparator CP3 of the third stage respectively. One end of the short-circuit switch M33 and one end of the short-circuit switch M34 are connected to the ground VSS, and the other end of the short-circuit switch M31 and the other end of the short-circuit switch M32 are connected to another input end of the comparator CP2 of the second stage and another input end of the comparator CP3 of the third stage respectively. The control ends of the short-circuit switches M31 to M34 are connected to the pad control circuit 130, and are configured to receive the control signal SW from the pad control circuit 130.

Normally, the pad control circuit 130 may output a control signal SW with logic 0 or a low level, to enable the short-circuit switches M31 to M34 to maintain in the off state, and to enable the operating switch M35 to maintain in the off state. In step S05, the pad control circuit 130 is changed to output a control signal SW with logic 1 or a high level, to enable the short-circuit switches M31 to M34 to perform the control signal SW to be turned on (that is, switch from the off state to the on state and remain in the on state), and also to enable the operating switch M35 to perform the control signal SW to be turned off (that is, switch from the on state to the off state and remain in the off state).

Referring to FIG. 1 to FIG. 4, in some embodiments, the current mirror circuit 121 includes a current mirror CRm and a current adjustment circuit CRt. The current adjustment circuit CRt is connected to the current mirror CRm and the pad control circuit 130. An input side of the current mirror CRm is connected between the power supply VDD and the current adjustment circuit CRt, and an output side of the current mirror CRm is connected between the power supply VDD and the switch circuit 123. The current adjustment circuit CRt is connected between the input side of the current mirror CRm and the ground VSS. The current adjustment circuit CRt is controlled by the pad control circuit 130. The current adjustment circuit CRt is configured to adjust the input current Iin. The current mirror CRm maps the input current Iin to the operating current Iout and provides the operating current Iout for the comparator group CPn through the switch circuit 123. The current adjustment circuit CRt has a plurality of levels to adjust the input current Iin to different current values. The pad control circuit 130 may output, based on a current operation and system setting of the memory control circuit 10, a selection signal SEL indicating a specified level to the current adjustment circuit CRt, so that the current adjustment circuit CRt provides impedance corresponding to the specified level based on the selection signal SEL, to enable the input current Iin to have a current value of the corresponding specified level. In step S05, the pad control circuit 130 outputs a selection signal SEL indicating a minimum level to the current adjustment circuit CRt, so that the current adjustment circuit CRt performs the selection signal SEL to enable the input current Iin to have a current value of the minimum level. In some embodiments, the selection signal SEL may be a digital signal.

In some embodiments, the current adjustment circuit CRt may be connected to the ground VSS through the current switch 127. In step S01 to step S06, the current switch 127 is in the on state. In step S07, the current switch 127 switches to and remains in the off state to turn off the entire receiver circuit RX by turning off the input current Iin of the current mirror CRm.

In some embodiments, the current mirror CRm can be implemented by a plurality of transistors M11 and M12. The current adjustment circuit CRt can be implemented by a plurality of transistors M13 and M14 and a plurality of resistors R1 and R2. The transistors M11, M12, M13, and M14 may be bipolar junction transistors, metal-oxide-semiconductor field-effect transistors, field-effect transistors, or insulated gate bipolar transistors.

In some embodiments, the current mirror CRm includes two transistors M11 and M12. The current adjustment circuit CRt includes two transistors M13 and M14 and two resistors R1 and R2. A first end of the transistor M11 is connected to the power supply VDD, and a second end of the transistor M11 is connected to a first end of the transistor M13 and a first end of the resistor R1. A third end of the transistor M11 is connected to the second end of the transistor M11 and a third end of the transistor M12. A first end of the transistor M12 is connected to the power supply VDD, and a second end of the transistor M12 is connected to the operating switch M35. In other words, the operating switch M35 is connected between the second end of transistor M12 and the power supply end of the comparator CP1 of the first stage. A second end of the transistor M13 and a second end of the resistor R1 are connected to a first end of the transistor M14 and a first end of the resistor R2. A second end of the transistor M14 and a second end of the resistor R2 are connected to a first end of the current switch 127. A second end of the current switch 127 is connected to the ground VSS. Control ends of the transistors M13 and M14 and the control end of the current switch 127 are connected to the pad control circuit 130, and receive the selection signal SEL and the mode signal PD respectively.

In some embodiments, the selection signal SEL may be a logic signal. The pad control circuit 130 respectively sends logic signals to the transistors M13 and M14 of the current adjustment circuit CRt, to enable the current adjustment circuit CRt to adjust the input current Iin based on the logic signals. The selection signal SEL may be a multi-bit logic signal, and a bit number thereof is the same as a quantity of the transistors M13 and M14 of the current adjustment circuit CRt. A plurality of bits SEL<1> and SEL<0> of the selection signal SEL correspond to the transistors M13 and M14 of the current adjustment circuit CRt respectively, so that each transistor M13/M14 can be controlled by the corresponding bit SEL<1>/SEL<0> in the selection signal SEL.

The two transistors M13 and M14 of the current adjustment circuit CRt are used as examples. In this case, the selection signal SEL comprises two bits SEL <1> and SEL <2> (referred to as a first bit SEL<1> and a second bit SEL<0> respectively below). The first bit SEL<1> corresponds to the transistor M13, and the second bit SEL<0> corresponds to the transistor M14. Therefore, the selection signal SEL has four bit combinations, and the four bit combinations correspond to the input current Iin of different four levels respectively.

When the pad control circuit 130 sends a selection signal SEL of 1 (that is, the first bit SEL<1> is 1) to the transistor M13 and sends a selection signal SEL of 1 (that is, the second bit SEL<0> is 1) to the transistor M14, the current adjustment circuit CRt may adjust the input current Iin to the maximum. The operating current Iout generated by mapping by the current mirror CRm may also be the maximum.

When the pad control circuit 130 sends a selection signal SEL of 0 (that is, the first bit SEL<1> is 0) to the transistor M13 and sends a selection signal SEL of 0 (that is, the second bit SEL<0> is 0) to the transistor M14, the current adjustment circuit CRt may adjust the input current Iin to the minimum. The operating current Iout generated by mapping by the current mirror CRm may also be the minimum.

When the pad control circuit 130 sends a selection signal SEL of 1 (that is, the first bit SEL<1> is 1) to the transistor M13 and sends a selection signal SEL of 0 (that is, the second bit SEL<0> is 0) to the transistor M14, or when the pad control circuit 130 sends a selection signal SEL of 0 (that is, the first bit SEL<1> is 0) to the transistor M13 and sends a selection signal SEL of 1 (that is, the second bit SEL<0> is 1) to the transistor M14, the current adjustment circuit CRt may adjust the input current Iin between the maximum value and the minimum value, for example, three-quarters of the maximum value and one-quarter of the maximum value respectively. Similarly, the operating current Iout generated by mapping by the current mirror CRm may also be between the maximum value and the minimum value.

Therefore, in this example, in step S05, the pad control circuit 130 forces to send a logic signal of 00 to the control ends of the two transistors M13 and M14 of the current adjustment circuit CRt, to enable the current adjustment circuit CRt to decrease the input current Iin to the minimum. In this case, the operating current Iout generated by mapping by the current mirror CRm is then decreased to the minimum, thereby decreasing the operating current Iout to the minimum.

In summary, according to the memory control circuit 10 and the control method thereof of any embodiment, the memory control circuit 10 that is idle can be switched from the power save mode to the deep power save mode, and the receiver circuit RX is enabled to enter the deep power save state from the power save state, thereby greatly reducing overall power consumption of the memory control circuit 10 without reducing system performance. In other words, when a read operation is needed, the memory control circuit 10 can instantly switch to the operating mode for performing the read operation from the deep power save mode, that is, the memory control circuit 10 can instantly wake up the receiver circuit RX to successfully receive read data. Although the technical content of the present invention has been revealed in various embodiments, it is not used to limit the scope of protection in the present invention. Changes or refinements made by any person having ordinary skill in the art without departing from the spirit of the present invention fall within the scope of protection intended in the present invention. Therefore, the scope of protection of the present invention should be subject to the content of the scope of patent application.

What is claimed is:

1. A memory control circuit, comprising:
an access control circuit, sending a read command, a write command, or a power save command;
a connection pad circuit, comprising:
a transceiver circuit; and
a receiver circuit, wherein the transceiver circuit and the receiver circuit are connected to a memory through an external pad; and
a pad control circuit, connected between the access control circuit and the receiver circuit, wherein the pad control circuit executes the read command to enable the receiver circuit to receive read data from the memory through the external pad; and the pad control circuit executes the write command or receives the read data to turn off output of the receiver circuit to enable the receiver circuit to enter a power save state, then executes the power save command to decrease an operating current of the receiver circuit and forces an internal signal of the receiver circuit to a level to enable the receiver circuit to enter a deep power save state.

2. The memory control circuit according to claim 1, wherein the receiver circuit comprises:
a current mirror circuit, controlled by the pad control circuit, and mapping an input current to generate the operating current;
a comparator group, connected to the external pad, and powered by the operating current;
an output stage, connected between the comparator group and the pad control circuit; and
a switch circuit, connected to the comparator group, and controlled by the pad control circuit.

3. The memory control circuit according to claim 2, wherein the switch circuit comprises:
an operating switch, connected between the current mirror circuit and the comparator group, and controlled by the pad control circuit, wherein
in the deep power save state, the pad control circuit further controls the operating switch to disconnect a power supply path that is between the current mirror circuit and the comparator group and that is configured to provide the operating current for the comparator group.

4. The memory control circuit according to claim 2, wherein in the deep power save state, the pad control circuit controls the switch circuit to connect a plurality of input ends of the comparator group to a power supply and to a ground respectively to force the internal signal of the receiver circuit to the level.

5. The memory control circuit according to claim 2, wherein in the power save state and the deep power save state, the pad control circuit forces the output stage to be in a non-output state to turn off the output of the receiver circuit.

6. The memory control circuit according to claim 5, wherein the output stage is an AND gate, the pad control circuit provides a logic signal to an input end of the AND gate to force the output stage to be in the non-output state, and the logic signal is 0.

7. The memory control circuit according to claim 2, wherein the receiver circuit further comprises:
a current switch, connected between the current mirror circuit and a ground, and executing a power down command to disconnect the current mirror circuit from the ground, to enable the receiver circuit to enter a power down state.

8. The memory control circuit according to claim 2, wherein the comparator group comprises:
a plurality of comparators, connected in series between the external pad and the pad control circuit, wherein
in the deep power save state, the pad control circuit controls the switch circuit to disconnect the current mirror circuit to turn off a first comparator in the plurality of comparators, and controls the switch circuit to connect two input ends of each of remaining comparators in the plurality of comparators to a power supply and to a ground respectively to force the internal signal of the receiver circuit to the level.

9. The memory control circuit according to claim 2, wherein the current mirror circuit comprises:
a current mirror, mapping the input current to the operating current; and
a current adjustment circuit, connected to the current mirror, controlled by the pad control circuit, and configured to adjust the input current.

10. A memory control circuit control method, comprising:
receiving a read command;
executing the read command to receive read data from a memory by a receiver circuit;
controlling the receiver circuit to enter a power save state after the read data is received or a write command is executed; and
executing a power save command to control the receiver circuit to enter a deep power save state from the power save state, wherein
a step of entering the power save state comprises: turning off output of the receiver circuit; and
a step of entering the deep power save state comprises: turning off the output of the receiver circuit; decreasing an operating current of the receiver circuit to the minimum; and
forcing an internal signal of the receiver circuit to a level.

11. The memory control circuit control method according to claim 10, further comprising:
entering a power down state from the power save state or the deep power save state, wherein
a step of entering the power down state comprises: turning off the receiver circuit.

12. The memory control circuit control method according to claim 10, wherein the step of entering the deep power save state further comprises: disconnecting a power supply path for providing the operating current to the receiver circuit.

13. The memory control circuit control method according to claim 10, wherein a step of forcing the internal signal of the receiver circuit to the level comprises: connecting a plurality of input ends of a comparator group of the receiver circuit to a power supply and to a ground respectively.

14. The memory control circuit control method according to claim 10, wherein a step of turning off the output of the receiver circuit comprises: forcing an output stage of the receiver circuit to be in a non-output state.

15. The memory power save control method according to claim 14, wherein the output stage is an AND gate, a step of forcing the output stage of the receiver circuit to be in the non-output state is to provide a logic signal to an input end of the AND gate, and the logic signal is 0.

16. The memory control circuit control method according to claim 10, a step of decreasing the operating current of the receiver circuit to the minimum comprises: decreasing an input current, wherein the operating current is generated by mapping the input current.

17. The memory control circuit control method according to claim 16, further comprising:
entering a power down state from the power save state or the deep power save state, wherein
a step of entering the power down state comprises: cutting off the input current.

18. The memory control circuit control method according to claim 10, wherein the receiver circuit comprises a plurality of comparators, and a step of forcing the internal signal of the receiver circuit to the level comprises: turning off a first comparator in the plurality of comparators, and connecting two input ends of each of remaining comparators in the plurality of comparators to a power supply and to a ground respectively.
